(19) United States
(12) Patent Application Publication
(10) Pub. No.: US 2025/0021216 A1
(43) Pub. Date: Jan. 16, 2025

(54) INFORMATION DISPLAY METHOD AND APPARATUS, DEVICE, AND STORAGE MEDIUM

(71) Applicant: Beijing Zitiao Network Technology Co., Ltd., Beijing (CN)

(72) Inventors: Jing LU, Beijing (CN); Siyi LIU, Beijing (CN)

(21) Appl. No.: 18/715,037

(22) PCT Filed: Nov. 29, 2022
(86) PCT No.: PCT/CN2022/134921

§ 371 Date: May 30, 2024

(30) Foreign Application Priority Data
Nov. 30, 2021 (CN) 202111444211.0

(51) Int. Cl. G06F 3/0484; G06F 3/0481

(52) U.S. Cl. CPC G06F 3/0484; G06F 3/0481

(57) ABSTRACT

Embodiments of the present disclosure disclose an information display method and apparatus, a device, and a storage medium. The method includes: in response to that a target preset entry on a target interface is triggered, determining a target display mode corresponding to the target preset entry; and displaying, on a preset information display interface, associated information corresponding to preset content according to the target display mode, where the target interface is used to display the preset content and includes at least two preset entries for triggering the display of the preset information display interface, the at least two preset entries include the target preset entry, and different preset entries correspond to different display modes of the preset information display interface.

The present disclosure claims priority to Chinese Patent Application No. 202111444211.0, filed with the China National Intellectual Property Administration on Nov. 30, 2021, which is incorporated herein by reference in its entirety.

### TECHNICAL FIELD

Embodiments of the present disclosure relate to the field of computer technologies, and for example, to an information display method and apparatus, a device, and a storage medium.

### BACKGROUND ART

With rapid development of Internet technology, various applications emerge in endlessly, providing users with increasingly rich interaction modes and interaction experiences.

In some application platforms, users are allowed to publish various forms of content, such as text, pictures, audios, or videos, for view by other users. Some content may have associated information, and the information can be displayed on an information display interface. However, current information display methods are not perfect and need to be improved.

### SUMMARY OF THE INVENTION

Embodiments of the present disclosure provide an information display method and apparatus, a storage medium, and a device, which can optimize solutions of information display in the related art and thus improve the efficiency of information consumption.

According to a first aspect, an embodiment of the present disclosure provides an information display method, the method including:
in response to that a target preset entry on a target interface is triggered, determining a target display mode corresponding to the target preset entry, where the target interface is used to display preset content and includes at least two preset entries for triggering the display of a preset information display interface, the at least two preset entries include the target preset entry, and different preset entries correspond to different display modes of the preset information display interface; and
displaying, on the preset information display interface, associated information corresponding to the preset content according to the target display mode.

According to a second aspect, an embodiment of the present disclosure provides an information display apparatus, the apparatus including:
a target display mode determination module configured to, in response to that a target preset entry on a target interface is triggered, determine a target display mode corresponding to the target preset entry, where the target interface is used to display preset content and includes at least two preset entries for triggering the display of a preset information display interface, the at least two preset entries include the target preset entry, and different preset entries correspond to different display modes of the preset information display interface; and
a display module configured to display, on the preset information display interface, associated information corresponding to the preset content according to the target display mode.

According to a third aspect, an embodiment of the present disclosure provides an electronic device, the device including a memory, a processor, and a computer program stored on the memory and executable on the processor, where the processor implements the information display method according to the embodiment of the present disclosure when executing the computer program.

According to a fourth aspect, an embodiment of the present disclosure provides a computer-readable storage medium having stored thereon a computer program that, when executed by a processor, causes the information display method according to the embodiment of the present disclosure to be implemented.

### BRIEF DESCRIPTION OF DRAWINGS

FIG. 1 is a schematic flowchart of an information display method according to an embodiment of the present disclosure;

FIG. 2 is a schematic flowchart of another information display method according to an embodiment of the present disclosure;

FIG. 3 is a schematic diagram of interface interaction of an information display method according to an embodiment of the present disclosure;

FIG. 4 is a schematic diagram of interface interaction of another information display method according to an embodiment of the present disclosure;

FIG. 5 is a schematic diagram of interface interaction of yet another information display method according to an embodiment of the present disclosure;

FIG. 6 is a block diagram of a structure of an information display apparatus according to an embodiment of the present disclosure; and

FIG. 7 is a block diagram of a structure of an electronic device according to an embodiment of the present disclosure.

### DETAILED DESCRIPTION OF THE INVENTION

The embodiments of the present disclosure will be described below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes.

It should be understood that the various steps described in the method implementations of the present disclosure may be performed in different orders, and/or performed in parallel. Furthermore, additional steps may be included and/or the execution of the illustrated steps may be omitted in the method implementations.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

In the following embodiments, both optional features and examples are provided in each embodiment, and each numbered embodiment should not be considered as only one technical solution.

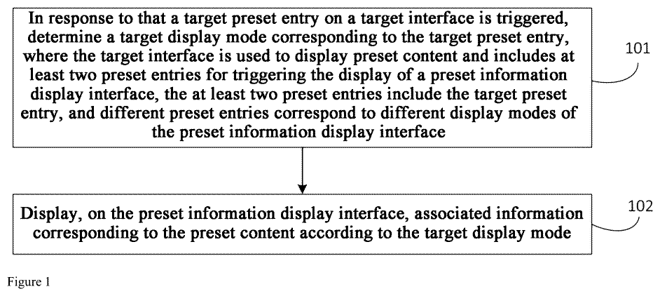

FIG. 1 is a schematic flowchart of an information display method according to an embodiment of the present disclosure. The method may be performed by an information display apparatus, where the apparatus may be implemented by software and/or hardware and may generally be integrated into an electronic device. The electronic device may be a mobile device, such as a mobile phone, a smart watch, a tablet computer, and a personal digital assistant, or may be another device such as a desktop computer. As shown in FIG. 1, the method includes the following steps.

Step 101: In response to that a target preset entry on a target interface is triggered, determine a target display mode corresponding to the target preset entry, where the target interface is used to display preset content and includes at least two preset entries for triggering the display of a preset information display interface, the at least two preset entries include the target preset entry, and different preset entries correspond to different display modes of the preset information display interface.

In this embodiment of the present disclosure, the target interface may be an interface in a preset application. The preset application may provide a content display function. The preset application may be installed in the electronic device. The target interface is used to display preset content. The preset content may be content provided by the preset application, or may be content published by a user via the preset application. The preset content may, for example, include text, pictures, audios, videos, etc. A display mode of the preset content on the target interface may be determined by the form of the preset content. With the preset application being a video-type application as an example, the preset content may be a video, and the video may be played on the target interface.

For example, there may be a plurality of pieces of associated information for the preset content, such as details information and comment information. The associated information may be displayed on the preset information display interface for view by users.

For example, at least two preset entries are displayed on the target interface during the process of displaying the preset content. The preset information display interface may be displayed by triggering one of the preset entries. The preset entry may be triggered by means of, for example, clicking, long-pressing, swiping, etc. Different preset entries may be triggered in the same or different ways. The preset entry may be displayed on the target interface in the form of an icon, a button, text, a link, etc., for example. The target preset entry may be understood as a currently triggered preset entry.

For example, after the target preset entry is triggered, the preset information display interface may be displayed. Since different preset entries correspond to different display modes of the preset information display interface, a corresponding target display mode may be determined based on the currently triggered target preset entry before the preset information display interface is displayed.

For example, subjects of different display modes may be set according to actual requirements. For example, a display number, a display position, a display region, a display style, a display duration, a display condition, etc. of the associated information that needs to be displayed may be set. Optionally, the different display modes of the preset information display interface include at least one of different display positions and display conditions of the associated information. The display position may be understood as a position where the associated information is displayed on the preset information display interface. The display condition may include, for example, a condition for switching or adjusting the display of the associated information on the preset information display interface, etc.

For example, a correspondence between different preset entries and different display modes may be preset. After it is detected that the target preset entry is triggered, the correspondence may be queried to determine a corresponding target display mode.

Step 102: Display, on the preset information display interface, associated information corresponding to the preset content according to the target display mode.

For example, after the target preset entry is triggered, the preset information display interface may be displayed. A relative relationship between the preset information display interface and the target interface may be set according to actual requirements. For example, the preset information display interface may be an interface that is overlaid over the target interface, and a size of the preset information display interface may be less than a size of the target interface. For another example, the preset information display interface may be embedded in the target interface. For yet another example, the preset information display interface may be an interface that is completely independent of the target interface. When the preset information display interface needs to be displayed, a jump may be made from the target interface to the preset information display interface.

For example, after the preset information display interface is entered, all or part of the associated information corresponding to the preset content may be displayed. A display mode of the associated information is determined by the target display mode, such that the preset information display interface is displayed in different display modes by triggering different preset entries.

In the information display method provided in this embodiment of the present disclosure, after it is detected that the target preset entry on the target interface is triggered, the target display mode corresponding to the target preset entry is determined, and the associated information is displayed on the preset information display interface according to the target display mode, where the target interface is used to display the preset content and includes at least two preset entries for triggering the display of the preset information display interface, the at least two preset entries include the target preset entry, and different preset entries correspond to different display modes of the preset information display interface. With the above technical solution, the display mode of the associated information of the content can be enriched, and an information display interface can be displayed in different modes by triggering different entries, which makes the information display mode more in line with actual requirements and facilitates improving the efficiency of information consumption.

In some embodiments, the preset information display interface is used to display at least two pieces of associated information corresponding to the preset content, and the at least two pieces of associated information include at least two categories of associated information. Division of the categories may be set according to actual situations. For example, one category may be set as attribute information about the preset content itself, such as details information and related link information. For another example, one category may be set as interactive information for the preset content, such as comment information and information about a number of favorites. In addition, the same kind of associated information as described above may also be divided into more fine-grained categories. For example, the comment information may be divided into comment information from a user who published the preset content, and comment information from users other than the user who published the preset content, etc. For another example, the comment information may be divided into comment information that has all or part of content displayed on the target interface, and comment information that is not displayed on the target interface, etc.

In some embodiments, an association between the different preset entries and different categories of associated information corresponding to the different preset entries satisfies a preset condition. A measurement index of the association between the preset entry and the associated information may be set according to actual situations. For example, the measurement index may be a degree of correlation between copywriting of the preset entry and content of the associated information, or may be a degree of correlation between an object that is displayed in association with the preset entry and the attribute information of the associated information, etc. The preset condition may be set based on the measurement index (for example, the degree of correlation as described above).

In some embodiments, the at least two pieces of associated information include first associated information and second associated information, the at least two preset entries include a first preset entry, and an association between the first preset entry and the first associated information satisfies a preset condition. The displaying the associated information on the preset information display interface according to the target display mode includes: when the target preset entry is the first preset entry, preferentially displaying the first associated information over the second associated information on the preset information display interface. It may be understood that when the user chooses to display the preset information display interface by triggering the first preset entry, the first associated information whose association with the first preset entry satisfies the preset condition may be preferentially displayed, such that the user's need to view information is satisfied.

Optionally, all or part of content of the first associated information is displayed on the target interface. For example, the first preset entry is displayed in association with all or part of the content of the first associated information.

For example, the preferential display may be reflected in terms of a completeness of display of the associated information, a display area, and an order of the display position, etc.

In some embodiments, the preferentially displaying the first associated information over the second associated information on the preset information display interface may include: on an initial display interface of the preset information display interface, a collapsing degree of the first associated information being less than a collapsing degree of the second associated information. The initial display interface may be understood as a preset information display interface that is first displayed after the target preset entry is triggered, and may subsequently change under a user operation or the trigger of other events, displaying a preset information display interface in another state. Collapsing may be understood as hiding all or part of content of the information, and the collapsing degree may be used to measure the completeness of display of the associated information. The collapsing degree may be understood as a binary value, which is divided into two states, i.e., the associated information is collapsed (1) and uncollapsed (0). The collapsing degree in the uncollapsed state is considered to be less than the collapsing degree in the collapsed state. Alternatively, the collapsing degree may also be a proportional value, that is, the smaller the proportional value, the higher the collapsing degree, and the lower the completeness, which indicates that the higher the proportion of hidden content to all content of the associated information. The collapsing degree may be quantified based on this proportion, and a value of this proportion may range from 0% (equivalent to all displayed) to 100% (equivalent to all hidden). The collapsing degree of the first associated information and the collapsing degree of the second associated information may be set according to actual requirements. For example, the collapsing degree of the first associated information is 0%, and the collapsing degree of the second associated information is 80%, etc.

For example, the preset information display interface may include an initial information display region, and the initial information display region is used to display at least part of the first associated information and the second associated information. When the initial information display region is limited and there is more content of the first associated information that needs to be displayed, it may not be possible to display all the content even when the collapsing degree is 0%. In this case, it may be understood that the initial information display region is completely used to display the first associated information, so as to display as much content of the first associated information as possible.

In some embodiments, the preferentially displaying the first associated information over the second associated information on the preset information display interface may include: on the initial display interface of the preset information display interface, an initial display area of the first associated information being greater than an initial display area of the second associated information. The initial display area may be understood as an area of a display region occupied by the associated information when the associated information is first displayed on the initial display interface. By setting a greater initial display area for the first associated information as compared to the second associated information, more content of the first associated information may be displayed. Optionally, the initial display area of the second associated information may be a minimum of 0.

In some embodiments, the preferentially displaying the first associated information over the second associated information on the preset information display interface may include: on the initial display interface of the preset information display interface, the first associated information being in a preset preferential display position. The preset preferential display position may be determined according to layout of the preset information display interface. A display position at the user's visual center or a display position that is viewed by the user first according to the user's browsing habits may be determined as the preset preferential display position. By displaying the first associated information in the preset preferential display position as compared to the second associated information, the first associated information may be viewed by the user more efficiently. For example, an uppermost part of the initial information display region is used as a preferential display position. When the user enters the preset information display interface via the first preset entry, the first associated information is displayed on the uppermost part of the initial information display region; and when the user enters the preset information display interface via the second preset entry, the second associated information is displayed on the uppermost part of the initial information display region. Due to factors such as the limited initial information display region and more content of the first associated information, there may also be a situation where the first associated information cannot be fully displayed even in the preset preferential display position. In this case, it may also be considered that the initial information display region is completely used to display the first associated information.

In some embodiments, the method may further include: when the first associated information is preferentially displayed over the second associated information on the preset information display interface, displaying a preset control on the preset information display interface if an initial information display region on the preset information display interface is completely occupied by the first associated information, where the preset control is used to display the second associated information on the preset information display interface. The initial information display region may be understood as an information display region in an initial state when the preset information display interface is entered. It may be understood that when other associated information cannot currently be displayed because of preferential display of the first associated information, the user may be prompted of the existence of the second associated information by providing the preset control, and the second associated information may be displayed quickly by triggering the preset control, thereby improving the efficiency of information display. A style of the preset control may be, for example, a button with copywriting such as “View second associated information” or “View more”.

In some embodiments, after the displaying a preset control on the preset information display interface, the method further includes: in response to a first trigger operation on the preset control, adjusting the display of the first associated information, and displaying the second associated information on the preset information display interface. It may be understood that when the user triggers the preset control, indicating that there is currently a need to view the second associated information, the display of the first associated information may be adjusted to leave a display space for display of the second associated information. The adjusting the display of the first associated information may include, for example, increasing the collapsing degree of the first associated information, or reducing the display area of the first associated information, etc.

In some embodiments, the adjusting the display of the first associated information includes: hiding content of the first associated information. It may be understood that the display of a first category of associated information may be temporarily blocked, thereby leaving more space for display of the second associated information. Optionally, while the content of the first associated information is hidden, the initial information display region may be completely used to display the second associated information.

For example, hiding the content of the first associated information, and displaying a second category of associated information on the preset information display interface may include: controlling the content of the first associated information to dynamically move out of the preset information display interface, and controlling content of the second associated information to dynamically move into the preset information display interface. The process of moving the information content may simulate a process of the user browsing information, making changes to content of the interface more in line with the user's browsing habits. For example, when the first associated information is displayed at the top of the interface, the content of the first associated information is controlled to move upwards and dynamically out of the interface, while the content of the second associated information is controlled to dynamically move into the interface, until all the content of the first associated information is moved out, and a start position of the content of the second associated information is moved to be displayed at the top of the preset information display interface.

In some embodiments, after the hiding content of the first associated information, the method further includes: in response to a preset information browsing operation, displaying the content of the first associated information on the preset information display interface. It may be understood that re-display of the first associated information is supported, such that the user's diverse needs to view information are satisfied. The preset information browsing operation may be, for example, a swipe operation acting on the preset information display interface, and a swiping direction may be opposite to a direction of movement when the content of the first associated information dynamically moves out of the preset information display interface.

In some embodiments, after the displaying a preset control on the preset information display interface, the method further includes: in response to a second trigger operation on the preset control, displaying content of the first associated information in a first preset region on the preset information display interface, and displaying the second associated information in a second preset region on the preset information display interface that is outside of the first preset region. It may be understood that it is convenient to switch to displaying the first associated information and the second associated information at the same time, to display richer associated information. Optionally, a size of the second preset region is greater than a size of the first preset region. It may be understood that the amount of the display region used for display of the content of the first associated information is reduced, thereby leaving more space for display of the second associated information.

Optionally, a first preset control, for example, an “Expand” button, may also be displayed in the first preset region. By triggering the first preset control, the first associated information may be resumed to be preferentially displayed over the second associated information. For example, when only the first associated information and the second associated information are currently displayed on the preset information display interface, and no other associated information needs to be displayed, a union set of the first preset region and the second preset region may be the initial information display region. The second trigger operation may be the same as or different from the first trigger operation. For example, the first trigger operation is clicking, and the second trigger operation is long-pressing, etc. When the second trigger operation is different from the first trigger operation, different display modes may be implemented by inputting different trigger operations.

In some embodiments, the at least two preset entries include a second preset entry, and the second preset entry is displayed in association with attribute information of the second associated information. In this way, a corresponding preset condition may be set based on an association between an object that is displayed in association with the second preset entry and attributes of the second associated information, such that the user can learn that an interface for display of the second associated information may be displayed by triggering the second preset entry. The attribute information may include a type or number of the second associated information, etc. Optionally, the content of the second associated information is not displayed on the target interface.

In some embodiments, the displaying the associated information on the preset information display interface according to the target display mode includes: when the target preset entry is the second preset entry, preferentially displaying the second associated information over the first associated information on the preset information display interface; and in response to a third trigger operation for a preset display condition, increasing a display priority of the first associated information. It may be understood that the second associated information is preferentially displayed, such that the need to view the second associated information that corresponds to the trigger of the second preset entry is satisfied, and increasing the display priority of the first category of associated information by triggering the preset display condition is supported, such that diverse needs to view information are satisfied.

For example, a second preset control corresponding to the preset display condition, such as a “View first associated information” button or an “Expand” button that is displayed in association with the displayed content of the first associated information, may be displayed on the preset information display interface, such that the display priority of the first associated information may be increased by the third trigger operation (such as clicking) that acts on the second preset control.

In some embodiments, the preferentially displaying the second associated information over the first associated information on the preset information display interface includes: displaying content of the first associated information in a first preset region on the preset information display interface, and displaying the second associated information in a second preset region on the preset information display interface that is outside of the first preset region, where a size of the second preset region is greater than a size of the first preset region. It may be understood that by controlling the size of the display region for display of the first category of associated information, and using more space for display of the second category of associated information, the need to view the second category of associated information is satisfied. Accordingly, the increasing a display priority of the first associated information may include: increasing a display area of the first associated information. For example, increasing the display area of the first associated information may be understood as dynamically increasing the size of the first preset region. Optionally, while the size of the first preset region is increased, the size of the second preset region may be dynamically reduced.

In some embodiments, the preferentially displaying the second associated information over the first associated information on the preset information display interface includes: displaying the second associated information on the preset information display interface, and hiding content of the first associated information. It may be understood that by hiding the content of the first associated information, more space may be left for display of the second category of associated information. Accordingly, the increasing a display priority of the first associated information may include: displaying the first associated information on the preset information display interface.

In some embodiments, it is also possible to display the content of the first associated information and then automatically switch to hiding the content of the first associated information. For example, the preferentially displaying the second associated information over the first associated information on the preset information display interface includes: displaying content of the first associated information in a first preset region on the preset information display interface, and displaying the second associated information in a second preset region on the preset information display interface that is outside of the first preset region, where a size of the second preset region is greater than a size of the first preset region; and automatically switching to hiding the content of the first associated information within a preset duration, and dynamically adjusting the display region of the second associated information. It may be understood that the display of the first associated information may be automatically and temporarily blocked, thereby leaving more space for display of the second associated information, and the first associated information may be displayed before being automatically hidden, which may prompt the user that the first associated information may be viewed on the interface. The preset duration may be set, for example, as 1 second according to actual requirements.

Optionally, after automatically switching to hiding the content of the first associated information, the method further includes: in response to a third trigger operation for a preset display condition, increasing a display priority of the first associated information. The increasing a display priority of the first associated information may include: displaying the content of the first associated information on the preset information display interface, to facilitate the user in viewing the first associated information. Optionally, the third trigger operation for the preset display condition may be reception of the preset information browsing operation.

In some embodiments, the preset information display interface includes a comment information display interface. Optionally, the first category of associated information may be title comment information on the preset content. The title comment information is set by a publisher of the preset content. All or part of content of the title comment information may be displayed on the target interface. The second category of associated information may be user comment information on the preset content. The user comment information is set by any user (including the publisher of the preset content) and is generally not displayed on the target interface.

In some embodiments, when a number of a second category of associated information to be displayed is less than or equal to a preset number threshold, before the displaying the associated information on the preset information display interface according to the target display mode, the method further includes: displaying a guide control for generating the second associated information. It may be understood that when there is a small number of second category of associated information, the user may be prompted to add the second associated information by displaying the guide control, which facilitates increasing the user's motivation to add the second associated information, and improving the utilization efficiency of the preset information display interface. Optionally, the guide control may be an input box, which may reduce the user's current operations, improving the efficiency of generating the second associated information.

In some embodiments, the displaying the associated information on the preset information display interface according to the target display mode includes: when the target preset entry is the second preset entry and a number of second associated information to be displayed is less than or equal to a preset number threshold, displaying the content of the first associated information in a third preset region on the preset information display interface, and displaying the second associated information in a fourth preset region on the preset information display interface that is outside of the third preset region. It may be understood that when there is a small number of second associated information, a plurality of pieces of associated information may be displayed simultaneously, and the second associated information may be fully displayed. In this way, the user does not need to input more information browsing operations to display more second associated information, improving the efficiency of information display. Optionally, a size of the fourth preset region is greater than a size of the third preset region. The third preset region may be the same as the above first preset region, and the fourth preset region may be the same as the above second preset region. Optionally, the size of the fourth preset region and the size of the third preset region may be dynamically determined based on a target size of a display region that is required when the second associated information is fully displayed. For example, when the target size does not exceed a preset size threshold, the target size may be set to the size of the fourth preset region, and a difference between an overall size of the initial information display region and the size of the fourth preset region may be set to the size of the third preset region. In this way, the display of the second associated information may be maximized.

In some embodiments, when a number of a second category of associated information to be displayed is less than or equal to a preset number threshold, the method further includes: displaying preset prompt information at the second preset entry, where the preset prompt information is used to prompt triggering of the second preset entry to generate the second associated information.

In some embodiments, when the guide control is an input box, the method further includes: in response to a close operation on the input box, displaying the content of the first associated information in the first preset region on the preset information display interface. In this way, it may be ensured that the first associated information is displayed normally after the input box is closed. Optionally, when the number of second associated information is not 0, the second associated information may also be displayed outside of the first preset region on the preset information display interface after the input box is closed.

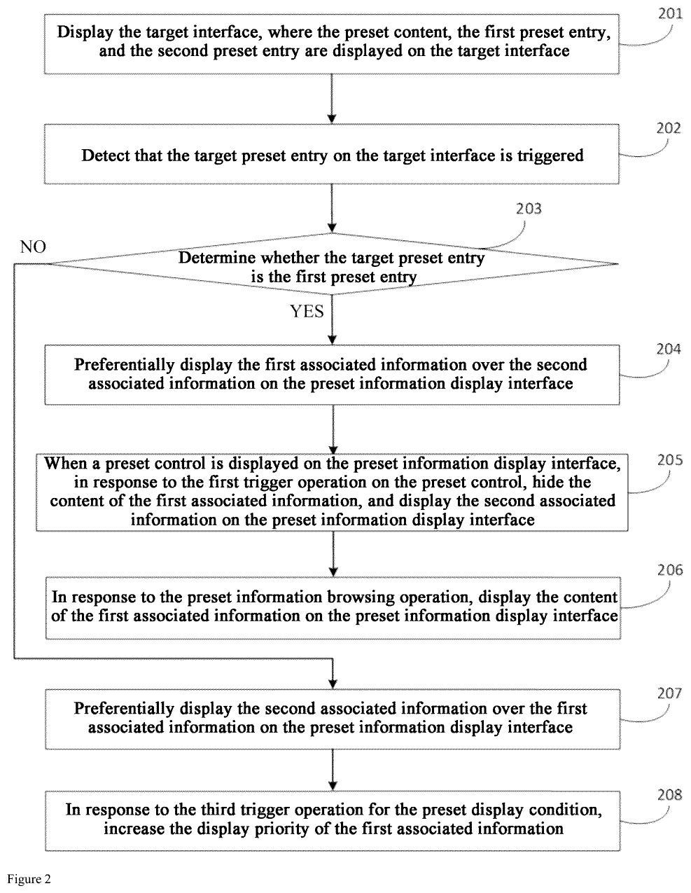

FIG. 2 is a schematic flowchart of an information display method according to an embodiment of the present disclosure. This embodiment of the present disclosure is modified based on various optional solutions in the above embodiments. With the preset information display interface being a comment information display interface as an example, the method includes the following steps.

Step 201: Display the target interface, where the preset content, the first preset entry, and the second preset entry are displayed on the target interface.

For example, an association between the first preset entry and the first associated information satisfies a first preset condition, and an association between the second preset entry and the second associated information satisfies a second preset condition. The first associated information may be the title comment information on the preset content, and the second associated information may be the user comment information on the preset content. The first preset condition may be the first preset entry being displayed in association with all or part of content of the first associated information. The second preset condition may be the second preset entry being displayed in association with attribute information of the second associated information. Optionally, the content of the second associated information is not displayed on the target interface.

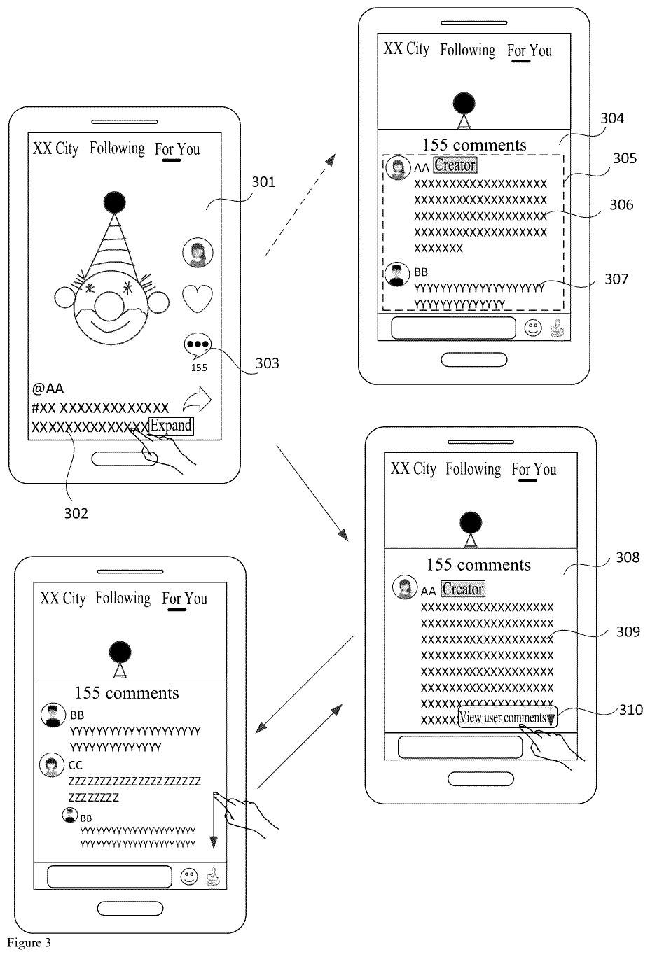

FIG. 3 is a schematic diagram of interface interaction of an information display method according to an embodiment of the present disclosure. As shown in FIG. 3, a clown video that is published by a user AA is displayed on a target interface 301, along with a first preset entry 302 and a second preset entry 303. A title control of the video is displayed at the first preset entry 302, and a comment control for triggering the display of user comment information is displayed at the second preset entry 303.

Step 202: Detect that the target preset entry on the target interface is triggered.

For example, the user may trigger the first preset entry 302 or the second preset entry 303 by means of clicking, etc.

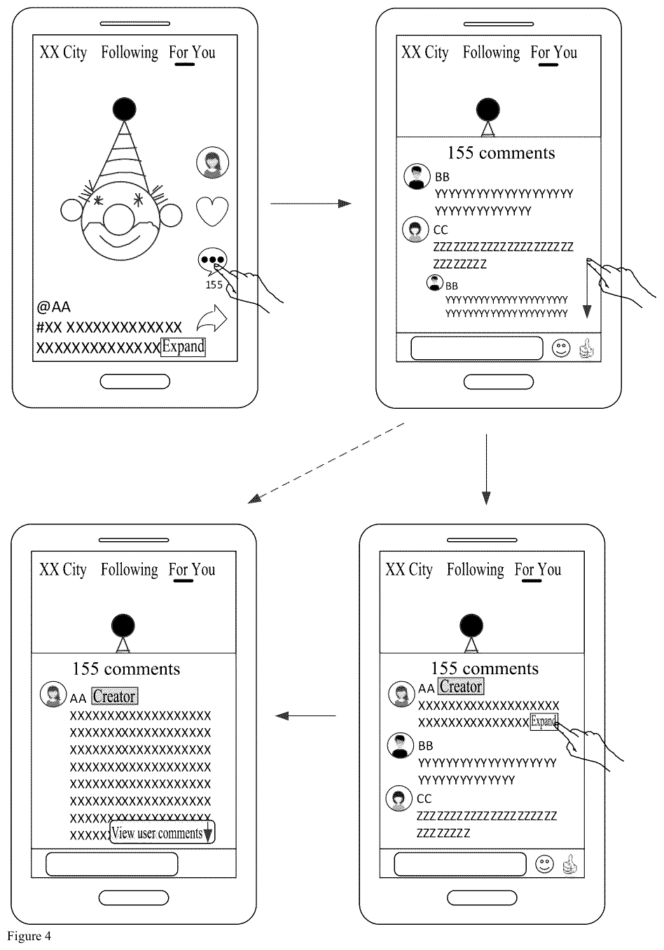

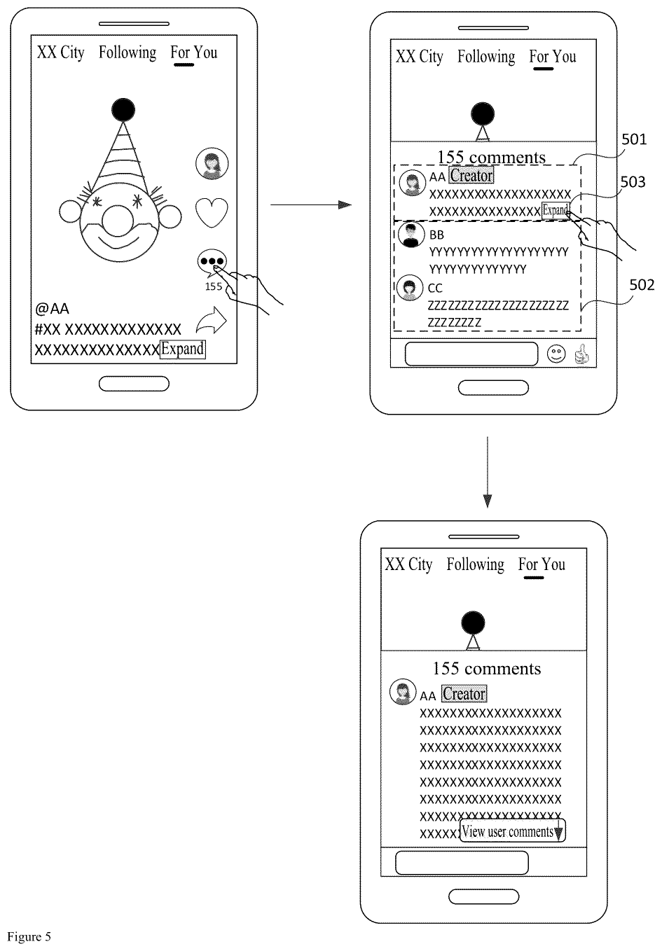

Step 203: Determine whether the target preset entry is the first preset entry. Based on a determination result that the target preset entry is the first preset entry, the process proceeds to step 204 where the display mode as shown in FIG. 3 is performed. Based on a determination result that the target preset entry is not the first preset entry, the process proceeds to step 207 where the display mode as shown in FIG. 4 or FIG. 5 is performed.

Step 204: Preferentially display the first associated information over the second associated information on the preset information display interface.

For example, on the initial display interface of the preset information display interface, the first associated information is in the preset preferential display position as compared to the second associated information. Optionally, the first associated information is preferentially displayed at the top of the initial display interface.

Optionally, before the associated information is displayed, it may also be determined whether the initial information display region on the preset information display interface is completely occupied by the first associated information. If yes, the preset control is displayed on the preset information display interface.

For example, when there is fewer content of the first associated information, the initial information display region may not be completely occupied. In this case, the second associated information may be displayed while displaying the first associated information. As shown in a schematic diagram of an interface indicated by the dotted arrow in FIG. 3, first associated information 306 with fewer content is preferentially displayed at the top of the initial information display region 305 on a first initial display interface 304. At this point, there is still space remaining in the initial information display region 305, and second associated information 307, such as user comment information published by a user BB, may then be displayed below the first associated information 306 with fewer content.

For example, when there is more content of the first associated information, the initial information display region may be completely occupied by the first associated information. In this case, the second associated information will not be displayed for the time being. As shown in FIG. 3, on a second initial display interface 308, the initial information display region is completely occupied by first associated information 309 with more content. At this time, a preset control, such as a “View user comments” button 310 in FIG. 3, may be displayed.

Step 205: When a preset control is displayed on the preset information display interface, in response to the first trigger operation on the preset control, hide the content of the first associated information, and display the second associated information on the preset information display interface.

For example, as shown in FIG. 3, when the user clicks the “View user comments” button 310, the content of the first associated information may be hidden, so that the second associated information may be displayed on the preset information display interface.

Step 206: In response to the preset information browsing operation, display the content of the first associated information on the preset information display interface.

For example, as shown in FIG. 3, the user may resume the display of the content of the first associated information by inputting an operation of swiping down, etc. on the preset information display interface.

Step 207: Preferentially display the second associated information over the first associated information on the preset information display interface.

When the user triggers the second preset entry, the second associated information is preferentially displayed.

FIG. 4 is a schematic diagram of interface interaction of another information display method according to an embodiment of the present disclosure. As shown in FIG. 4, in this step, the second associated information may be displayed only, while the first associated information may be hidden. For example, the user comment information published by the user BB, user comment information published by a user CC, and user comment information that is made by the user BB in response to the user comment information published by the user CC may be displayed.

FIG. 5 is a schematic diagram of interface interaction of yet another information display method according to an embodiment of the present disclosure. As shown in FIG. 5, the content of the first associated information may be displayed in a first preset region 501 on the preset information display interface, and the second associated information may be displayed in a second preset region 502 on the preset information display interface that is outside of the first preset region 501, where a size of the second preset region 502 is greater than a size of the first preset region 501. As can be seen, an initial display area of the second associated information is greater than an initial display area of the first associated information, and at the same time, a collapsing degree of the first associated information is greater than a collapsing degree of the second associated information, thereby resulting in a preferential display of the second associated information.

Step 208: In response to the third trigger operation for the preset display condition, increase the display priority of the first associated information.

As shown in FIG. 4, the third trigger operation for the preset display condition may also be the preset information browsing operation. When the user inputs an operation of swiping down and a swiping distance exceeds a preset distance threshold, the display priority of the first associated information may be increased (as shown in the schematic diagram of interface indicated by the dotted arrow in the figure). Optionally, as shown in FIG. 4, after the user inputs the operation of swiping down, the first associated information with a non-zero collapsing degree may be displayed in the first preset region, and then after an “Expand” button is triggered, the display priority of the first associated information may be increased.

As shown in FIG. 5, a control for triggering the preset display condition, such as an “Expand” button 503, may also be displayed in the first preset region 501. When the user triggers the “Expand” button 503, it may be considered that the third trigger operation for the preset display condition is received, and the display priority of the first associated information is then increased.

According to the information display method provided in this embodiment of the present disclosure, two preset entries may be simultaneously displayed on the target interface for displaying the preset content. Associations between each of the two preset entries and the title comment information and the user comment information on the comment information display interface satisfy different preset conditions. When the target preset entry is triggered, a corresponding display mode of the comment information display interface is determined based on the trigger of the target preset entry, and comment information whose association with the target preset entry satisfies a corresponding preset condition is preferentially displayed on the initial display interface of the comment information display interface. Moreover, switching between different comment information for display and dynamic adjustments for the display mode are supported, thereby enriching the display form of the comment information, and improving the efficiency of information consumption.

On the basis of the above embodiments, step 205 may also be replaced by: when a preset control is displayed on the preset information display interface, in response to the second trigger operation on the preset control, displaying the content of the first associated information in the first preset region on the preset information display interface, and displaying the second associated information in the second preset region on the preset information display interface that is outside of the first preset region. In this way, the first associated information and the second associated information may be displayed simultaneously. For example, for the display effect, reference may be made to the second schematic diagram of interface in FIG. 4 and the above relevant descriptions.

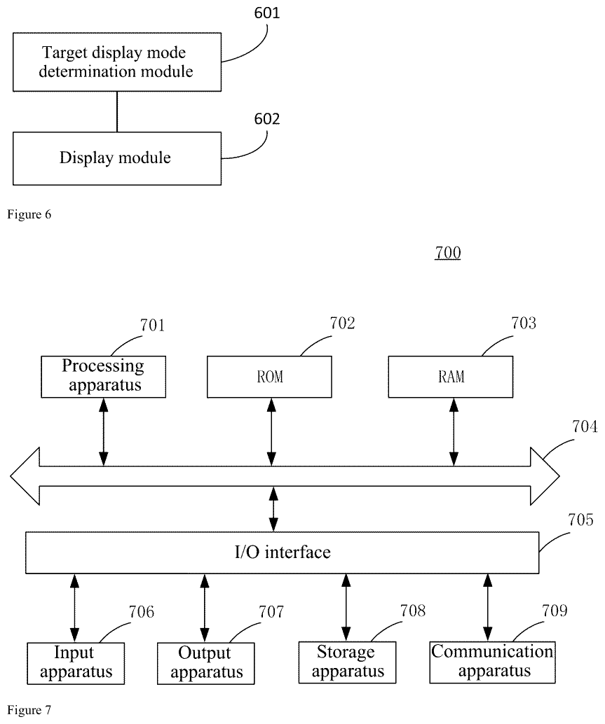

FIG. 6 is a block diagram of a structure of an information display apparatus according to an embodiment of the present disclosure. The apparatus may be implemented by software and/or hardware, may generally be integrated into an electronic device, and may display information by performing the information display method. As shown in FIG. 6, the apparatus includes: a target display mode determination module 601 configured to, in response to that a target preset entry on a target interface is triggered, determine a target display mode corresponding to the target preset entry, where the target interface is used to display preset content and includes at least two preset entries for triggering the display of a preset information display interface, the at least two preset entries include the target preset entry, and different preset entries correspond to different display modes of the preset information display interface; and a display module 602 configured to display, on the preset information display interface, associated information corresponding to the preset content according to the target display mode.

According to the information display apparatus provided in this embodiment of the present disclosure, the display mode of the associated information of the content may be enriched, and an information display interface may be displayed using different modes by triggering different entries, which makes the information display mode more in line with actual requirements and facilitates improving the efficiency of information consumption.

Optionally, the preset information display interface is used to display at least two pieces of associated information corresponding to the preset content, and the different display modes of the preset information display interface include at least one of different display positions and display conditions of the associated information.

Optionally, the at least two pieces of associated information include at least two categories of associated information, and an association between the different preset entries and different categories of associated information satisfies a preset condition.

Optionally, the at least two pieces of associated information include first associated information and second associated information, the at least two preset entries include a first preset entry, and an association between the first preset entry and the first associated information satisfies a preset condition.

The display module is configured to: when the target preset entry is the first preset entry, preferentially display the first associated information over the second associated information on the preset information display interface.

Optionally, the preferentially displaying the first associated information over the second associated information on the preset information display interface includes at least one of the following:
on an initial display interface of the preset information display interface, a collapsing degree of the first associated information being less than a collapsing degree of the second associated information;
on the initial display interface of the preset information display interface, an initial display area of the first associated information being greater than an initial display area of the second associated information; and
on the initial display interface of the preset information display interface, the first associated information being in a preset preferential display position.

Optionally, the apparatus further includes: a preset control display module configured to, when the first associated information is preferentially displayed over the second associated information on the preset information display interface, display a preset control on the preset information display interface if an initial information display region on the preset information display interface is completely occupied by the first associated information, where the preset control is used to display the second associated information on the preset information display interface.

Optionally, the display module is further configured to: after the preset control is displayed on the preset information display interface, in response to a first trigger operation on the preset control, adjust the display of the first associated information, and display the second associated information on the preset information display interface.

Optionally, the adjusting the display of the first associated information includes: hiding content of the first associated information.

Optionally, the display module is further configured to: after the hiding content of the first associated information, in response to a preset information browsing operation, display the content of the first associated information on the preset information display interface.

Optionally, the display module is further configured to: after the preset control is displayed on the preset information display interface, in response to a second trigger operation on the preset control, display content of the first associated information in a first preset region on the preset information display interface, and display the second associated information in a second preset region on the preset information display interface that is outside of the first preset region.

Optionally, the at least two preset entries include a second preset entry, and the second preset entry is displayed in association with attribute information of the second associated information.

The display module is configured to: when the target preset entry is the second preset entry, preferentially display the second associated information over the first associated information on the preset information display interface; and in response to a third trigger operation for a preset display condition, increase a display priority of the first associated information.

Optionally, the preferentially displaying the second associated information over the first associated information on the preset information display interface includes: displaying content of the first associated information in a first preset region on the preset information display interface, and displaying the second associated information in a second preset region on the preset information display interface that is outside of the first preset region, where a size of the second preset region is greater than a size of the first preset region. Accordingly, the increasing a display priority of the first associated information includes: increasing a display area of the first associated information.

Optionally, the preferentially displaying the second associated information over the first associated information on the preset information display interface includes: displaying the second associated information on the preset information display interface, and hiding content of the first associated information. Accordingly, the increasing a display priority of the first associated information includes: displaying the first associated information on the preset information display interface.

Optionally, the preset information display interface includes a comment information display interface.

Optionally, the apparatus further includes:
a guide control display module configured to, when a number of a second category of associated information to be displayed is less than or equal to a preset number threshold, before the displaying the associated information on the preset information display interface according to the target display mode, display a guide control for generating the second associated information.

Reference is made to FIG. 7 below, which is a schematic diagram of a structure of an electronic device 700 suitable for implementing the embodiments of the present disclosure. The electronic device in this embodiment of the present disclosure may include a mobile terminal such as a mobile phone, a notebook computer, a digital broadcast receiver, a personal digital assistant (PDA), a tablet computer (Portable Android Device, PAD), a portable media player (PMP), and a vehicle-mounted terminal (such as a vehicle navigation terminal), and a fixed terminal such as a digital television (that is, a digital TV) and a desktop computer. The electronic device shown in FIG. 7 is merely an example.

As shown in FIG. 7, the electronic device 700 may include a processing apparatus (e.g., a central processor, a graphics processor, etc.) 701, and the processing apparatus 701 may perform a variety of appropriate actions and processing in accordance with a program stored in a read-only memory (ROM) 702 or a program loaded from a storage apparatus 708 into a random-access memory (RAM) 703. The RAM 703 further stores various programs and data required for the operation of the electronic device 700. The processing apparatus 701, the ROM 702, and the RAM 703 are connected to each other through a bus 704. An input/output (I/O) interface 705 is also connected to the bus 704.

Generally, the following apparatuses may be connected to the I/O interface 705: an input apparatus 706 including, for example, a touch screen, a touchpad, a keyboard, a mouse, a camera, a microphone, an accelerometer, a gyroscope, etc.; an output apparatus 707 including, for example, a liquid crystal display (LCD), a speaker, a vibrator, etc.; a storage apparatus 708 including, for example, a tape, a hard disk, etc.; and a communication apparatus 709. The communication apparatus 709 may allow the electronic device 700 to perform wireless or wired communication with other devices to exchange data. Although FIG. 7 shows the electronic device 700 having various apparatuses, it should be understood that it is not required to implement or have all of the shown apparatuses. It may be an alternative to implement or have more or fewer apparatuses.

Optionally, according to an embodiment of the present disclosure, the process described above with reference to the flowcharts may be implemented as a computer software program. For example, this embodiment of the present disclosure includes a computer program product, which includes a computer program carried on a non-transitory computer-readable medium, where the computer program includes program code for performing the methods shown in the flowcharts. In such an embodiment, the computer program may be downloaded from a network through the communication apparatus 709 and installed, installed from the storage apparatus 708, or installed from the ROM 702. When the computer program is executed by the processing apparatus 701, the above-mentioned functions defined in the method of the embodiment of the present disclosure are performed.

It should be noted that the above computer-readable medium described in the present disclosure may be a computer-readable signal medium, a computer-readable storage medium, or a combination thereof. The computer-readable storage medium may be, for example, electric, magnetic, optical, electromagnetic, infrared, or semiconductor systems, apparatuses, or devices, or a combination thereof. Examples of the computer-readable storage medium may include: an electrical connection having at least one wire, a portable computer magnetic disk, a hard disk, a random access memory (RAM), a read-only memory (ROM), an erasable programmable read-only memory (such as an electronic programmable read only memory (EPROM) or flash memory), an optical fiber, a portable compact disk read-only memory (CD-ROM), an optical storage device, a magnetic storage device, or a suitable combination thereof. In the present disclosure, the computer-readable storage medium may be a tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including an electromagnetic signal, an optical signal, or a suitable combination thereof. The computer-readable signal medium may also be a computer-readable medium other than the computer-readable storage medium. The computer-readable signal medium can send, propagate, or transmit a program used by or in combination with an instruction execution system, apparatus or device. The program code contained in the computer-readable medium may be transmitted by a suitable medium, including: electric wires, optical cables, radio frequency (RF), etc., or a suitable combination thereof.

The above computer-readable medium may be contained in the above electronic device. Alternatively, the computer-readable medium may exist independently, without being assembled into the electronic device.

The above computer-readable medium carries at least one program that, when executed by the electronic device, causes the electronic device to: in response to that a target preset entry on a target interface is triggered, determine a target display mode corresponding to the target preset entry, where the target interface is used to display preset content and includes at least two preset entries for triggering the display of a preset information display interface, the at least two preset entries include the target preset entry, and different preset entries correspond to different display modes of the preset information display interface; and display, on the preset information display interface, associated information corresponding to the preset content according to the target display mode.

The computer program code for performing the operations in the present disclosure may be written in one or more programming languages or a combination thereof, where the programming languages include an object-oriented programming language, such as Java, Smalltalk, or C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the circumstance involving a remote computer, the remote computer may be connected to a computer of a user over any type of network, including a local area network (LAN) or a wide area network (WAN), or may be connected to an external computer (for example, connected over the Internet using an Internet service provider).

The flowcharts and block diagrams in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains at least one executable instruction for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The modules described in the embodiments of the present disclosure may be implemented by means of software, or may be implemented by means of hardware. The names of the modules do not constitute a limitation on the modules themselves in some cases. For example, the display module may also be described as “a module for displaying the associated information on the preset information display interface according to the target display mode”.

The functions described herein above may be performed at least partially by at least one hardware logic component. For example, exemplary types of hardware logic components that may be used include: a field-programmable gate array (FPGA), an application-specific integrated circuit (ASIC), application-specific standard parts (ASSP), a system-on-chip (SOC) system, a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include electronic, magnetic, optical, electromagnetic, infrared, or semiconductor systems, apparatuses, or devices, or a suitable combination thereof. Examples of the machine-readable storage medium may include an electrical connection based on at least one wires, a portable computer disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or a suitable combination thereof.

According to one or more embodiments of the present disclosure, an information display method is provided, the method including:
in response to that a target preset entry on a target interface is triggered, determining a target display mode corresponding to the target preset entry, where the target interface is used to display preset content and includes at least two preset entries for triggering the display of a preset information display interface, the at least two preset entries include the target preset entry, and different preset entries correspond to different display modes of the preset information display interface; and
displaying the associated information on the preset information display interface according to the target display mode.

In one embodiment, the preset information display interface is used to display at least two pieces of associated information corresponding to the preset content, and the different display modes of the preset information display interface include at least one of different display positions and display conditions of the associated information.

In one embodiment, the at least two pieces of associated information include at least two categories of associated information, and an association between the different preset entries and different categories of associated information satisfies a preset condition.

In one embodiment, the at least two pieces of associated information include first associated information and second associated information, the at least two preset entries include a first preset entry, and an association between the first preset entry and the first associated information satisfies a preset condition; and

the displaying the associated information on the preset information display interface according to the target display mode includes:
when the target preset entry is the first preset entry, preferentially displaying the first associated information over the second associated information on the preset information display interface.

In one embodiment, the preferentially displaying the first associated information over the second associated information on the preset information display interface includes at least one of the following:
on an initial display interface of the preset information display interface, a collapsing degree of the first associated information being less than a collapsing degree of the second associated information;
on the initial display interface of the preset information display interface, an initial display area of the first associated information being greater than an initial display area of the second associated information; and
on the initial display interface of the preset information display interface, the first associated information being in a preset preferential display position.

In one embodiment, the method further includes: when the first associated information is preferentially displayed over the second associated information on the preset information display interface, displaying a preset control on the preset information display interface in response to determining that an initial information display region on the preset information display interface is completely occupied by the first associated information, where the preset control is used to display the second associated information on the preset information display interface.

In one embodiment, after the displaying a preset control on the preset information display interface, the method further includes:
in response to a first trigger operation on the preset control, adjusting the display of the first associated information, and displaying the second associated information on the preset information display interface.

In one embodiment, the adjusting the display of the first associated information includes: hiding content of the first associated information.

In one embodiment, after the hiding content of the first associated information, the method further includes: in response to a preset information browsing operation, displaying the content of the first associated information on the preset information display interface.

In one embodiment, after the displaying a preset control on the preset information display interface, the method further includes:
in response to a second trigger operation on the preset control, displaying content of the first associated information in a first preset region on the preset information display interface, and displaying the second associated information in a second preset region on the preset information display interface that is outside of the first preset region.

In one embodiment, the at least two preset entries include a second preset entry, and the second preset entry is displayed in association with attribute information of the second associated information; and

the displaying the associated information on the preset information display interface according to the target display mode includes:
when the target preset entry is the second preset entry, preferentially displaying the second associated information over the first associated information on the preset information display interface; and
in response to a third trigger operation for a preset display condition, increasing a display priority of the first associated information.

In one embodiment, the preferentially displaying the second associated information over the first associated information on the preset information display interface includes: displaying the second associated information on the preset information display interface, and hiding content of the first associated information.

Accordingly, the increasing a display priority of the first associated information includes: displaying the first associated information on the preset information display interface.

In one embodiment, the preferentially displaying the second associated information over the first associated information on the preset information display interface includes: displaying content of the first associated information in a first preset region on the preset information display interface, and displaying the second associated information in a second preset region on the preset information display interface that is outside of the first preset region, where a size of the second preset region is greater than a size of the first preset region.

Accordingly, the increasing a display priority of the first associated information includes: increasing a display area of the first associated information.

In one embodiment, the preset information display interface includes a comment information display interface.

In one embodiment, when a number of a second category of associated information to be displayed is less than or equal to a preset number threshold, before the displaying the associated information on the preset information display interface according to the target display mode, the method further includes: displaying a guide control for generating the second associated information.

According to one or more embodiments of the present disclosure, an information display apparatus is provided, the apparatus including:
a target display mode determination module configured to, in response to that a target preset entry on a target interface is triggered, determine a target display mode corresponding to the target preset entry, where the target interface is used to display preset content and includes at least two preset entries for triggering the display of a preset information display interface, the at least two preset entries include the target preset entry, and different preset entries correspond to different display modes of the preset information display interface; and
a display module configured to display, on the preset information display interface, associated information corresponding to the preset content according to the target display mode.

1. An information display method, comprising:
in response to that a target preset entry on a target interface is triggered, determining a target display mode corresponding to the target preset entry, wherein the target interface is used to display preset content and comprises at least two preset entries for triggering the display of a preset information display interface, the at least two preset entries comprise the target preset entry, and different preset entries correspond to different display modes of the preset information display interface; and
displaying, on the preset information display interface, associated information corresponding to the preset content according to the target display mode.

2. The method according to claim 1, wherein the preset information display interface is used to display at least two pieces of associated information corresponding to the preset content, and the different display modes of the preset information display interface comprise at least one of different display positions and display conditions of the associated information.

3. The method according to claim 2, wherein the at least two pieces of associated information comprise at least two categories of associated information, and an association between the different preset entries and different categories of associated information satisfies a preset condition.

4. The method according to claim 2, wherein the at least two pieces of associated information comprise first associated information and second associated information, the at least two preset entries comprise a first preset entry, and an association between the first preset entry and the first associated information satisfies a preset condition; and
the displaying the associated information on the preset information display interface according to the target display mode comprises:
when the target preset entry is the first preset entry, preferentially displaying the first associated information over the second associated information on the preset information display interface.

5. The method according to claim 4, wherein the preferentially displaying the first associated information over the second associated information on the preset information display interface comprises at least one of the following:
on an initial display interface of the preset information display interface, a collapsing degree of the first associated information being less than a collapsing degree of the second associated information;
on the initial display interface of the preset information display interface, an initial display area of the first associated information being greater than an initial display area of the second associated information; and
on the initial display interface of the preset information display interface, the first associated information being in a preset preferential display position.

6. The method according to claim 4, wherein the method further comprises:
when the first associated information is preferentially displayed over the second associated information on the preset information display interface, displaying a preset control on the preset information display interface in response to determining that an initial information display region on the preset information display interface is completely occupied by the first associated information, wherein the preset control is used to display the second associated information on the preset information display interface.

7. The method according to claim 6, wherein after the displaying a preset control on the preset information display interface, the method further comprises:
in response to a first trigger operation on the preset control, adjusting the display of the first associated information, and displaying the second associated information on the preset information display interface.

8. The method according to claim 7, wherein the adjusting the display of the first associated information comprises: hiding content of the first associated information.

9. The method according to claim 8, wherein after the hiding content of the first associated information, the method further comprises:
in response to a preset information browsing operation, displaying the content of the first associated information on the preset information display interface.

10. The method according to claim 6, wherein after the displaying a preset control on the preset information display interface, the method further comprises:
in response to a second trigger operation on the preset control, displaying content of the first associated information in a first preset region on the preset information display interface, and displaying the second associated information in a second preset region on the preset information display interface that is outside of the first preset region.

11. The method according to claim 4, wherein the at least two preset entries comprise a second preset entry, and the second preset entry is displayed in association with attribute information of the second associated information; and
the displaying the associated information on the preset information display interface according to the target display mode comprises:
when the target preset entry is the second preset entry, preferentially displaying the second associated information over the first associated information on the preset information display interface; and
in response to a third trigger operation for a preset display condition, increasing a display priority of the first associated information.

12. The method according to claim 11, wherein the preferentially displaying the second associated information over the first associated information on the preset information display interface comprises:
displaying the second associated information on the preset information display interface, and hiding content of the first associated information; and
the increasing a display priority of the first associated information comprises: displaying the first associated information on the preset information display interface.

13. The method according to claim 11, wherein the preferentially displaying the second associated information over the first associated information on the preset information display interface comprises:
displaying content of the first associated information in a first preset region on the preset information display interface, and displaying the second associated information in a second preset region on the preset information display interface that is outside of the first preset region, wherein a size of the second preset region is greater than a size of the first preset region; and
the increasing a display priority of the first associated information comprises: increasing a display area of the first associated information.

14. The method according to claim 1, wherein the preset information display interface comprises a comment information display interface.

15. The method according to claim 4, wherein when a number of a second category of associated information to be displayed is less than or equal to a preset number threshold, before the displaying the associated information on the preset information display interface according to the target display mode, the method further comprises: displaying a guide control for generating the second associated information.

16. (canceled)

17. A computer device, comprising a memory, a processor, and a computer program stored on the memory and executable on the processor, wherein the processor, when executing the computer program, is caused to:
in response to that a target preset entry on a target interface is triggered, determine a target display mode corresponding to the target preset entry, wherein the target interface is used to display preset content and comprises at least two preset entries for triggering the display of a preset information display interface, the at least two preset entries comprise the target preset entry, and different preset entries correspond to different display modes of the preset information display interface; and
display, on the preset information display interface, associated information corresponding to the preset content according to the target display mode.

18. A non-transitory computer-readable storage medium having stored thereon a computer program that, when executed by a processor, causes the processor to:
in response to that a target preset entry on a target interface is triggered, determine a target display mode corresponding to the target preset entry, wherein the target interface is used to display preset content and comprises at least two preset entries for triggering the display of a preset information display interface, the at least two preset entries comprise the target preset entry, and different preset entries correspond to different display modes of the preset information display interface; and
display, on the preset information display interface, associated information corresponding to the preset content according to the target display mode.

19. The computer device according to claim 17, wherein the preset information display interface is used to display at least two pieces of associated information corresponding to the preset content, and the different display modes of the preset information display interface comprise at least one of different display positions and display conditions of the associated information.

20. The computer device according to claim 19, wherein the at least two pieces of associated information comprise at least two categories of associated information, and an association between the different preset entries and different categories of associated information satisfies a preset condition.

21. The computer device according to claim 19, wherein the at least two pieces of associated information comprise first associated information and second associated information, the at least two preset entries comprise a first preset entry, and an association between the first preset entry and the first associated information satisfies a preset condition; and
the processor is further caused to:
when the target preset entry is the first preset entry, preferentially display the first associated information over the second associated information on the preset information display interface.
